(19) United States
(12) Patent Application Publication
(10) Pub. No.: US 2014/0023449 A1
(43) Pub. Date: Jan. 23, 2014

(54) CUTTING HEAD COMPRISING A DRILL TIP AND A DRILL HAVING SUCH A CUTTING HEAD

(71) Applicants: Kenth-Ove Jonsson, Norrkoping (SE); Tommy Wikstrom, Linghem (SE)

(72) Inventors: Kenth-Ove Jonsson, Norrkoping (SE); Tommy Wikstrom, Linghem (SE)

(21) Appl. No.: 14/009,832

(22) PCT Filed: Mar. 27, 2012
(86) PCT No.: PCT/EP2012/055426

§ 371 Date: Oct. 4, 2013

(30) Foreign Application Priority Data
Apr. 5, 2011 (EP) 11161167.9

(51) Int. Cl. B23B 51/02

(52) U.S. Cl. CPC B23B 51/02
USPC 408/231; 408/227

(57) ABSTRACT

A cutting head includes a drill tip having a chisel edge, at least two main cutting edges, each extending between a central end at the chisel edge and an outer end. A recess is associated with each main cutting edge and located at each side of the chisel edge. Each recess includes a chip breaking groove extending along the main cutting edge and spaced from the main cutting edge by a distance. Furthermore, a twist drill has a cutting head and drill tip.

### TECHNICAL FIELD OF THE INVENTION AND BACKGROUND ART

The present invention relates to a cutting head comprising a drill tip, the drill tip comprising:
a chisel edge,
at least two main cutting edges, each main cutting edge extending between a central end at said chisel edge and an outer end, and
a recess associated with each main cutting edge and located at each side of the chisel edge,
   as well as a twist drill having such a cutting head.

A replaceable cutting head detachably attachable to a tool body in the form of a shank of a drill, is shown in for example WO 2009/128775 A1, and cutting heads being an integral part of a drill are known.

Such a cutting head is used for drilling holes in steel and similar hard material and preferably made of hard metal, such as cemented tungsten carbide. The invention is not restricted to any particular dimensions of such cutting heads, but such cutting heads are usually used to drill holes with a diameter of 8-32 mm.

Furthermore, the cutting head has normally two said main cutting edges, but the number of cutting edges may just as well be for instance 3 or 4.

The chisel edge of such a cutting head is formed at the leading end of the cutting head, and it will rather than performing a substantial cutting function merely push work piece material cut by the main cutting edges ahead of it in the direction of rotation. The longer the chisel edge the larger the power consumption and torque necessary to move the drill tip through a work piece, which is the reason of arranging a said recess associated with each main cutting edge, so that the length of the chisel edge at the drill tip is reduced. Such a recess may therefor also be called or produce a thinning. Thus, the arrangement of such recesses tends to reduce power and torque consumption by the chisel edge.

There is of course an ongoing attempt to further reduce such consumption of power and torque when drilling with such a cutting head. Furthermore, the drilling will result in crater wear and flank wear of the cutting head restricting the lifetime thereof. The forces necessary to apply on the work piece through said main cutting edges for drilling through a work piece have also an influence upon said lifetime.

### SUMMARY OF THE INVENTION

The object of the present invention is to provide a cutting head of the type defined in the introduction being improved in at least some aspect with respect to such cutting heads already known.

This object is according to the invention obtained by providing each said recess of such a cutting head with a chip breaking groove extending along the main cutting edge but spaced from the main cutting edge by a distance.

Such a chip breaking groove arranged at a distance from the main cutting edge will act as a natural crater, which results in an increased chip angle in the recess (thinning) where the chip angle is small, so that the chips cut may be better shaped and by that the cutting forces may be reduced. Besides a reduced consumption of power and torque when drilling this will result in less production of heat and also less strains upon the cutting edges, which all together results in a prolonged lifetime of the cutting head. By arranging said chip breaking groove spaced from the main cutting edge by a distance these advantages may be achieved without weakening the main cutting edge in question or the chisel edge.

According to an embodiment of the invention said distance of the chip breaking groove to the main cutting edge is 0.01-0.5 mm, preferably 0.05-0.3 mm. This is a suitable distance for obtaining a desired change of said chip angle resulting in the advantages mentioned above while ensuring that the main cutting edge and the chisel edge are not detrimentally weakened.

According to another embodiment of the invention each said recess is defined by a radius which is larger than said distance. This will have a positive influence upon the efforts to reduce consumption of power when drilling in a work piece by said cutting edge.

According to another embodiment of the invention each said chip breaking groove and said main cutting edge make in a direction towards said chisel edge an angle of 0°-15° with each other. This relationship between the extensions of the chip breaking groove and the main cutting edge has a positive influence upon the ability of the chip breaking groove to reduce cutting forces of the main cutting edge by assisting this to better shape chips cut thereby.

According to another embodiment of the invention being a further development of the embodiment last mentioned said angle is ≧2° or ≧5°. Accordingly, the chip breaking groove and the main cutting edge associated therewith converge in the direction towards said chisel edge, and said distance between them defined in an embodiment of the invention is then the shortest distance therebetween, i.e. close to said chisel edge.

According to another embodiment of the invention each said chip breaking groove has a depth of 0.05-1 mm, preferably 0.05-0.5 mm. This is a suitable depth for a chip breaking groove of a cutting head according to the present invention.

According to another embodiment of the invention each said chip breaking groove has a width of 0.5-3 mm, preferably 1.0-2.0 mm. This is a suitable width of said chip breaking groove resulting in a favourable breaking of chips cut by the associated main cutting edge.

The invention also relates to a twist drill comprising a cutting head according to the present invention, and the function and advantages thereof appear clearly from the above disclosure of the different embodiments of a cutting head according to the present invention.

Further advantages as well as advantageous features of the invention will appear from the following description.

### BRIEF DESCRIPTION OF THE DRAWINGS

With reference to the appended drawings, below follows a specific description of embodiments of the invention cited as examples.

In the drawings:

FIG. 1 is a side elevation of a twist drill according to an embodiment of the present invention,

FIG. 2 is a view of a cutting head according to a first embodiment of the invention being a part of the twist drill shown in FIG. 1,

FIG. 3 is a top plan view of the cutting head according to FIG. 2,

FIG. 4 is a cross-section view according to the line IV-IV in FIG. 3 with the ship breaking groove in an enlarged view, and

FIG. 5 is a perspective view of a twist drill according to a second embodiment of the invention with the drill tip thereof in an enlarged view.

### DETAILED DESCRIPTION OF EMBODIMENTS OF THE INVENTION

A twist drill 1 according to a first embodiment of the invention having a shank 2 and a cutting head 3 with a drill tip 4 is shown in FIG. 1. The cutting head is in this embodiment of the invention removably attached to the shank, for instance as disclosed in WO 2009/128775 A1, which is incorporated herein by reference.

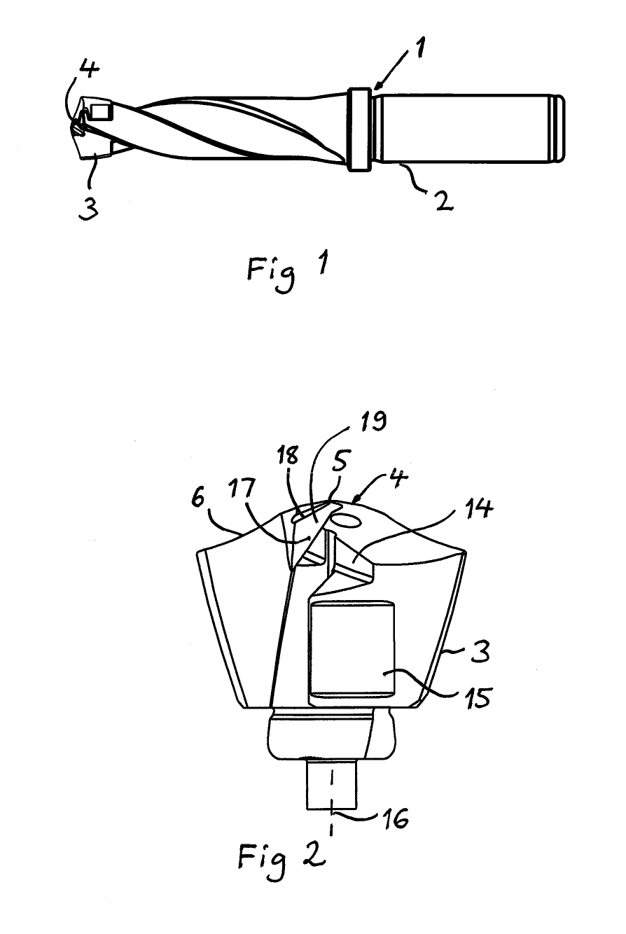

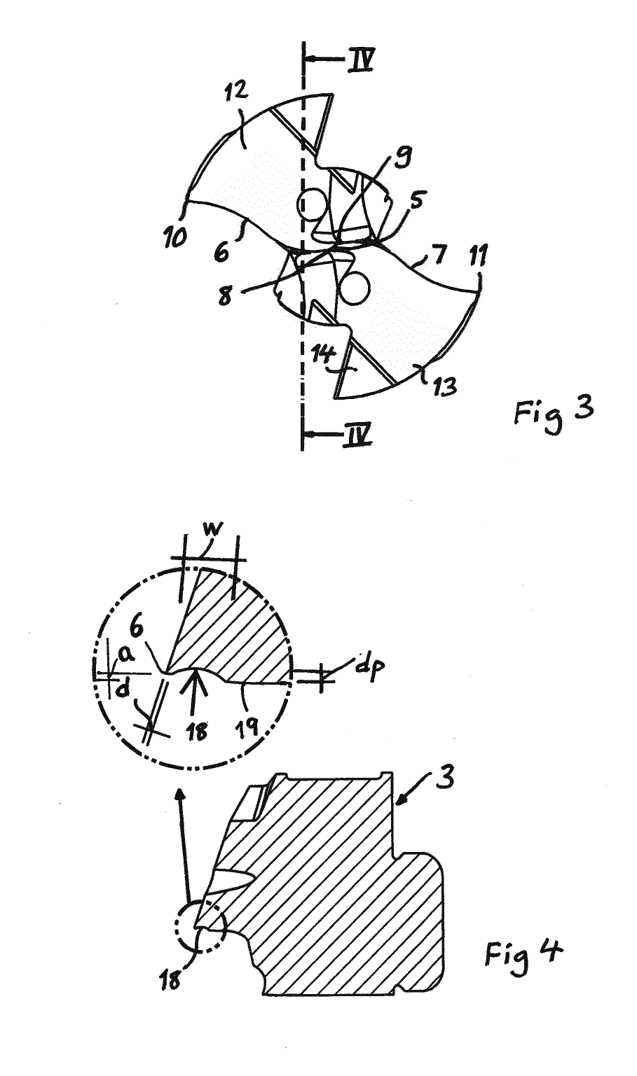

The cutting head 3 of the twist drill in FIG. 1 will now be disclosed more in detail while making reference to FIGS. 2-4. The cutting head has a chisel edge 5 and two main cutting edges 6, 7 each extending between a central end 8, 9 at the chisel edge 5 and an outer end 10, 11.

Each main cutting edge forms one border of a flank 12, 13. The chisel edge 5 may be formed by the intersection of the flanks. A shoulder 14 is provided on the heel side of each flank opposite to the respective main cutting edge and is used to assist in preventing axial displacement of the cutting head from the shank of the twist drill when the cutting head is attached to the shank as shown in FIG. 1. The cutting head may comprise means for constituting a part of a quick coupling such as a bayonet coupling. Generally, two-piece drills are less exact in for example radial run-out and therefore it is of great importance for their stability that the chip formation is favourable. Flat surfaces 15 directed perpendicularly to the intended axis of rotation 16 of the cutting head are arranged for tightening and loosening the cutting head with respect to the shank for establishing and breaking a bayonet-type coupling there-between.

A recess 17 is associated with each main cutting edge and located at each side of the chisel edge. The recess 17 slopes generally axially rearwardly. These recesses result in a thinning of the flank 12, 13 in the region of the chisel edge, which is favourable, since the smaller the flank and the chisel edge, the less power consumption and torque necessary to move the drill tip through a work piece.

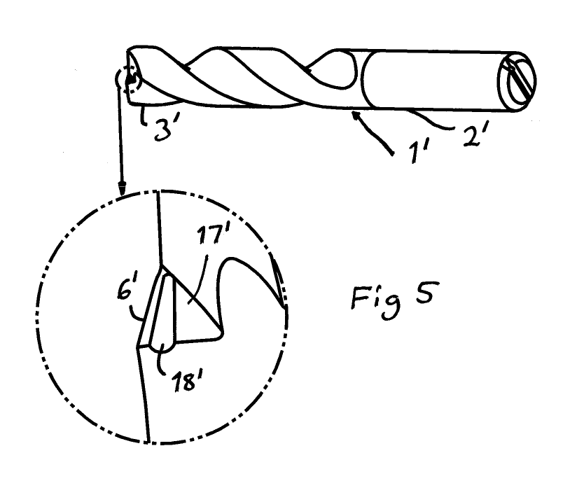

The cutting head according to the invention has a chip breaking groove 18 arranged in each said recess 17 in a wall 19 thereof connecting the recess to the main cutting edge and the chisel edge. The main cutting edge 6 may be spaced a distance a from a plane of the wall 19. The chip breaking groove 18 extends along the main cutting edge spaced from the main cutting edge by a distance d (see FIG. 4). This distance is 0.01-0.5 mm, preferably 0.05-0.3 mm, where it is shortest. The distance may vary, since the chip breaking groove and the main cutting edge may in a direction towards said chisel edge make an angle of 0°-15° with each other, and it is advantageous when this angle is 2° or 5°, so that the main cutting edge and the chip breaking groove will then converge slightly towards the chisel edge. The chip breaking groove has a depth dp of 0.05-1 mm, preferably 0.05-0.5 mm, and a width w of 0.5-3 mm, preferably 1.0-2.0 mm. Said distance d will ensure that the main cutting edge and the chisel edge are not weakened by the presence of the chip breaking groove. As already explained the chip breaking groove 18 will when drilling through a work piece result in an increased or more positive chip angle reducing the cutting forces and by that lowering the heat generation and thus prolonging the lifetime of the respective main cutting edge and by that of the cutting head.

FIG. 5 illustrates a twist drill 1′ according to a second embodiment of the invention, which differs from the above-mentioned cutting head in that the cutting head 3′ and the shank 2′ are integral parts of the twist drill. A chip breaking groove 18′ is arranged in each recess 17′ of this cutting head and extends along and at a distance from the respective main cutting edge 6′.

The cutting head is preferably made of sintered boron nitride (BN) especially of cubic boron nitride (CBN), but it may also be of polycrystalline boron nitride (PCBN). However, the invention should not be restricted to the use of this material for the cutting head, but other materials suited for such cutting heads, such as sintered cemented carbide, are conceivable. The cutting head may be coated with one or more layers, such as Al₂O₃, TiN, etc.

The invention is of course not in any way restricted to the embodiments described above, but many possibilities to modifications thereof will be apparent to a person with ordinary skill in the art without departing from the scope of the invention as defined in the appended claims.

The disclosures in EP Patent Application No. 11161167.9, from which this application claims priority, are incorporated herein by reference.

1. (canceled)

2. A cutting head according to claim 12, wherein the distance is 0.01-0.5 mm, preferably 0.05-0.3 mm.

3. A cutting head according to claim 12, wherein each said recess is defined by a radius which is larger than said distance.

4. A cutting head according to claim 12, wherein each said chip breaking groove and said main cutting edge form an angle of 0°-15° with each other in a direction towards said chisel edge.

5. A cutting head according to claim 4, wherein said angle is ≧2° or ≧5°.

6. A cutting head according to claim 12, wherein said chip breaking groove has a depth of 0.05-1 mm, preferably 0.05-0.5 mm.

7. A cutting head according to claim 12, wherein said chip breaking groove has a width of 0.5-3 mm, preferably 1.0-2.0 mm.

8. A cutting head according to claim 12, further comprising means for constituting a part of a quick coupling, such as a bayonet coupling.

9. A twist drill including a cutting head having a drill tip, the drill tip comprising:
a chisel edge;
at least two main cutting edges, each main cutting edge extending between a central end at said chisel edge and an outer end; and
a recess associated with each main cutting edge and located at each side of the chisel edge, wherein each recess includes a chip breaking groove extending along a respective main cutting edge and spaced from the main cutting edge by a distance.

10. A twist drill according to claim 9, further comprising a shank to which the cutting head is removably attachable.

11. A twist drill according to claim 10, wherein the shank includes means for constituting a part of a quick coupling, such as a bayonet coupling.

12. A cutting head having a drill tip, the drill tip comprising:
a chisel edge;
at least two main cutting edges, each main cutting edge extending between a central end at said chisel edge and an outer end; and
a recess associated with each main cutting edge and located at each side of the chisel edge, wherein each recess includes a chip breaking groove extending along a respective main cutting edge and spaced from the main cutting edge by a distance.
